(19) United States
(12) Patent Application Publication
(10) Pub. No.: US 2012/0014708 A1
(43) Pub. Date: Jan. 19, 2012

(54) PRE-FIXING HEATING DEVICE, IMAGE FORMING APPARATUS, AND IMAGE FORMING METHOD

(75) Inventor: Keiji Yuge, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/151,425

(22) Filed: Jun. 2, 2011

Related U.S. Application Data
(60) Provisional application No. 61/364,544, filed on Jul. 15, 2010.

(51) Int. Cl. G03G 15/00; G03G 15/20

(52) U.S. Cl. 399/96; 399/320

(57) ABSTRACT

An image forming apparatus includes: a heating device which is installed upstream from a fixing device in a recording medium carrying direction and heats an image forming face of a recording medium; a temperature sensor which detects temperature of a heating device; a cooling device which cools a transfer belt; a cooling fan which cools the cooling device, a photoconductive drum temperature sensor which is provided for each photoconductive drum and detects temperature of the photoconductive drum; and a control unit which controls heating temperature of the heating device to higher than a toner outer layer glass transition temperature Tg and lower than a toner melting point Tm and controls the temperature of the photoconductive drum to lower than a threshold temperature.

### CROSS-REFERENCE TO RELATED APPLICATIONS

This application is based upon and claims the benefit of priority from the prior the U.S. Patent Application No. 61/364,544, filed on Jul. 15, 2010, and the entire contents of which are incorporated herein by reference.

### FIELD

Embodiments described herein relate generally to a pre-fixing heating device, an image forming apparatus, and an image forming method.

### BACKGROUND

In an electronic image forming apparatus such as a printer or copy machine, a developer is supplied by a developing device to an electrostatic latent image on a photoconductive drum and a developer image is generated. Moreover, in the image forming apparatus, this developer image is transferred to a recording medium and the recording medium with the developer image transferred thereto is heated and pressurized to fix the developer image to the recording medium.

In recent years, with increased awareness of energy-saving, developers having low melting points are used in order to save energy used in the fixing process. However, when the fixing temperature is lowered, the temperature of the recording medium before reaching a fixing device may cause fixing failure.

In view of this point, an image forming apparatus is proposed wherein a paper supply unit in which the recording media are stored is provided with a heater for heating the entire recording media in the paper supply unit.

However, this image forming apparatus consumes power unnecessarily by heating even recording media on which no image is to be formed.

Also, an image forming apparatus having a heating unit for recording medium upstream from a transfer device in a recording medium carrying direction is proposed.

However, the heated recording medium heats image carriers such as a transfer belt and a photoconductive drum and may cause deterioration in the quality of image forming.

Thus, there is demand for a pre-fixing heating device, an image forming apparatus and an image forming method by which the temperature of a recording medium prior to a fixing process is maintained within a predetermined range and overheating of a transfer unit is prevented.

### BRIEF DESCRIPTION OF THE DRAWINGS

FIG. 1 shows the configuration of an image forming apparatus.

FIG. 2 is a block diagram showing the configuration of the image forming apparatus.

FIG. 3 is a flowchart showing operation of the image forming apparatus.

### DETAILED DESCRIPTION

Throughout this description, the embodiments and examples shown should be considered as exemplars, rather than limitations on the apparatus and methods of the present embodiments.

Hereinafter, an embodiment of a pre-fixing heating device, an image forming apparatus and an image forming method will be described in detail with reference to the drawings. Here, the image forming apparatus encompasses a copy machine, MFP (multi-functional peripheral) and printer.

According to one embodiment, an image forming apparatus includes: an image carrier; a developer image carrier which holds a developer image; a fixing device which fixes the developer image transferred from the developer image carrier to a recording medium; a heating device which is installed upstream from the fixing device in a recording medium carrying direction and heats an image forming face of the recording medium; an image carrier temperature sensor which detects temperature of the image carrier; and a cooling device which cools the developer image carrier based on the detected temperature from the image carrier temperature sensor.

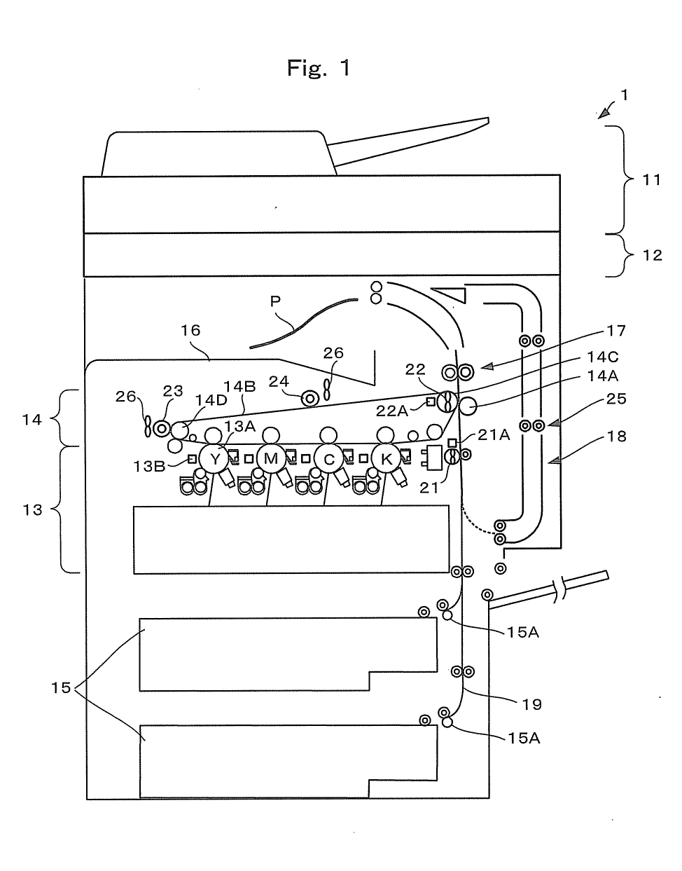

FIG. 1 shows the configuration of an image forming apparatus 1 of this embodiment. As shown in FIG. 1, the image forming apparatus 1 includes an automatic document feeder 11, an image reading unit 12, an image forming unit 13, a transfer unit 14, a recording medium carrying mechanism 19, and a paper supply unit 15.

The image forming apparatus 1 has the automatic document feeder 11 on top of the body in away that allows opening and closing. The automatic document feeder 11 has a document carrying mechanism which takes out document sheets, one by one, from a paper supply tray and carries the sheets to a paper discharge tray.

With the document carrying mechanism, the automatic document feeder 11 carries document sheets, one by one, to a document reading part of the image reading unit 12. Alternatively, the automatic document feeder 11 can be opened and a document can be placed on a document table of the image reading unit 12.

The image reading unit 12 has a carriage including an exposure lamp to expose light to a document and a first reflection mirror, plural second reflection mirrors retained to the body frame of the image forming apparatus 1, a lens block, and a CCD (charge coupled device) as an image reading sensor.

The carriage stands still in the document reading part or reciprocates below the document table and reflects light of the exposure lamp reflected from the document, to the first reflection mirror. The plural second reflection mirrors reflect the reflected light from the first reflection mirror to the lens block. The lens block outputs the reflected light to the CCD. The CCD converts the incident light to an electrical signal and outputs the electrical signal as an image signal to the image forming unit 13.

The image forming unit 13 has a laser casting unit, a photoconductive drum 13A as an image carrier, and a developing device, for each of yellow Y, magenta M, cyan C and black K.

The laser casting unit, which is an electrostatic latent image forming unit, casts a laser beam to the photoconductive drum 13A based on an image signal and forms an electrostatic latent image on the photoconductive drum 13A. The developing device supplies a developer to the photoconductive drum 13A and forms a developer image from the electrostatic latent image.

The recording medium carrying mechanism 19 has a pickup mechanism 15A which takes out recording media, one by one, at the most upstream part on the paper supply unit 15 side.

The pickup mechanism 15A takes out recording media, one by one, from the paper supply unit 15 and delivers the recording media to the recording medium carrying mechanism 19. The recording medium carrying mechanism 19 carries the recording media to the transfer unit 14.

The transfer unit 14 has a transfer belt 14B as a developer image carrier, a transfer roller 14A, and a fixing device 17. The transfer belt 14B is laid over a transfer counter-roller 14C that faces the transfer roller 14A. The transfer belt 14B, as an image carrier, receives the developer image transferred from the photoconductive drum 13A and carries the developer image. The transfer roller 14A applies a voltage to transfer the developer image on the transfer belt 14B to the recording medium that is carried thereto. The fixing device 17 heats and pressurizes the developer image and thus fixes the developer image to the recording medium.

In another embodiment of the image forming apparatus 1, the developer image is transferred directly from the photoconductive drum 13A to the recording medium. In this case, the transfer roller 14A is arranged facing the photoconductive drum 13A.

The recording medium P discharged from a paper discharge port is stacked on a paper discharge tray 16 as a holding unit which holds the recording medium.

The image forming apparatus 1 further includes a pre-fixing heating device which is installed upstream from the fixing device 17 in the recording medium carrying direction and heats the image forming face of the recording medium, and a cooling device which cools the transfer belt 14B. The image forming apparatus 1 has at least one of a pre-transfer heating device 21 and a transfer unit heating device 22, as a pre-fixing heating device.

The image forming apparatus 1 has the pre-transfer heating device 21 upstream from the transfer roller 14A in the recording medium carrying direction and on the recording medium transfer face side, that is, the image carrier side, of a recording medium carrying path.

The pre-transfer heating device 21 need not be in contact with the recording medium as long as the pre-transfer heating device 21 can heat the image forming face of the recording medium to a pre-heating temperature Tp, which will be described later.

An example of contact heating of the recording medium may use a heating roller. The heating roller has a heating device inside. As the heating device, for example, a thermal head, halogen heater, graphite heater, IH (induction heater) or heat-generating lamp can be employed.

As an example of non-contact heating of the recording medium, for example, a thermal head, halogen heater, graphite heater, IH or heat-generating lamp can be employed.

The image forming apparatus 1 has a temperature sensor 21A which detects the temperature of the pre-transfer heating device 21.

The image forming apparatus 1 has the transfer unit heating device 22 which heats the transfer unit 14. The transfer unit heating device 22 heats at least one of the transfer counter-roller 14C and the transfer belt 14B.

When the transfer unit heating device 22 heats the transfer counter-roller 14C, the transfer unit heating device 22 is installed inside or outside the transfer counter-roller 14C.

When the transfer unit heating device 22 heats the transfer belt 14B, the transfer unit heating device 22 is installed downstream from the photoconductive drum 13A in the turning direction of the transfer belt 14B and upstream from the transfer counter-roller 14C in the turning direction of the transfer belt 14B.

The transfer unit heating device 22 need not be in contact with the transfer unit 14 as long as the transfer unit heating device 22 can heat the transfer unit 14 to a pre-heating temperature Tp, which will be described later.

An example of contact heating of the transfer unit 14 may use a heating roller. The heating roller has a heating device inside. As the heating device, for example, a thermal head, halogen heater, graphite heater, IH or heat-generating lamp can be employed.

As an example of non-contact heating of the transfer unit 14, for example, a thermal head, halogen heater, graphite heater, IH or heat-generating lamp can be employed.

The transfer unit heating device 22 can also be installed inside the transfer counter-roller 14C.

The image forming apparatus 1 has a temperature sensor 22A which detects the temperature of the transfer unit heating device 22.

The image forming apparatus 1 has at least one of a transfer belt cooling device 24 and a transfer belt counter-roller cooling device 23, as a cooling device.

The image forming apparatus 1 has the transfer belt cooling device 24 downstream from the transfer counter-roller 14C in the turning direction of the transfer belt 14B and upstream from the photoconductive drum 13A in the turning direction of the transfer belt 14B.

The image forming apparatus 1 has the transfer belt counter-roller cooling device 23 at a position facing a transfer belt stretching roller 14D which has the transfer belt 14B laid thereon together with the transfer counter-roller 14C, with the transfer belt 14B situated between the transfer belt counter-roller cooling device 23 and the transfer belt stretching roller 14D.

The image forming apparatus 1 has a switchback cooling device 25 in a switchback unit 18 which reverses the sides of the recording medium after image forming.

The transfer belt cooling device 24, the transfer belt counter-roller cooling device 23 and the switchback cooling device 25 may have any structure as long as these devices can cool the transfer belt 14B.

The transfer belt cooling device 24, the transfer belt counter-roller cooling device 23 and the switchback cooling device 25 can use, for example, a cooling pipe with a coolant enclosed.

The image forming apparatus 1 has a cooling fan 26 which cools the transfer belt cooling device 24 and the transfer belt counter-roller cooling device 23 as cooling devices, and a photoconductive drum temperature sensor 133 which is provided for each photoconductive drum 13A and detects the temperature of the photoconductive drum 13A.

The image forming apparatus 1 heats the image forming face of the recording medium to the pre-heating temperature Tp using the pre-fixing heating device according to the results of detection from the temperature sensors 21A and 22A.

The pre-heating temperature Tp is set within the following range.

Cooling fan-off temperature Toff<cooling fan-on temperature Ton<toner outer layer glass transfer temperature Tg<pre-heating temperature Tp<toner melting point Tm<fixing temperature Ts<100° C.

Here, the cooling fan-off temperature Toff is the temperature at which the cooling fan 26 is stopped. The cooling fan-on temperature Ton is the threshold temperature at which the cooling fan 26 is driven. The toner outer layer glass transfer temperature Tg is the temperature at which glass transition occurs in the outer layer of toner particles contained in the developer. The toner melting point Tm is the temperature at which toner particles melt. The fixing temperature Ts is the heating temperature set for the fixing device 17.

The image forming apparatus 1 of this embodiment is suitable for a case where, for example, a developer with a low melting point whose toner outer layer glass transition temperature Tg is 45° C. or lower is used.

The pre-heating temperature Tp is higher than the toner outer layer glass transition temperature Tg and lower than the toner melting point Tm. Therefore, the developer is more likely to adhere to the recording medium and less likely to melt than when not heated.

According to the result of the detection by the photoconductive drum temperature sensor 13B, the image forming apparatus 1 drives the cooling fan when the temperature of the photoconductive drum 13A is higher than the cooling fan-on temperature Ton, and stops the cooling fan 26 that is driven, when the temperature of the photoconductive drum 13A is lower than the cooling fan-off temperature Toff.

Thus, the image forming apparatus 1 can lower the temperature of the photoconductive drum 13A to less than the cooling fan-on temperature Ton, and can stop the cooling fan 26 and save electricity when cooling is not needed.

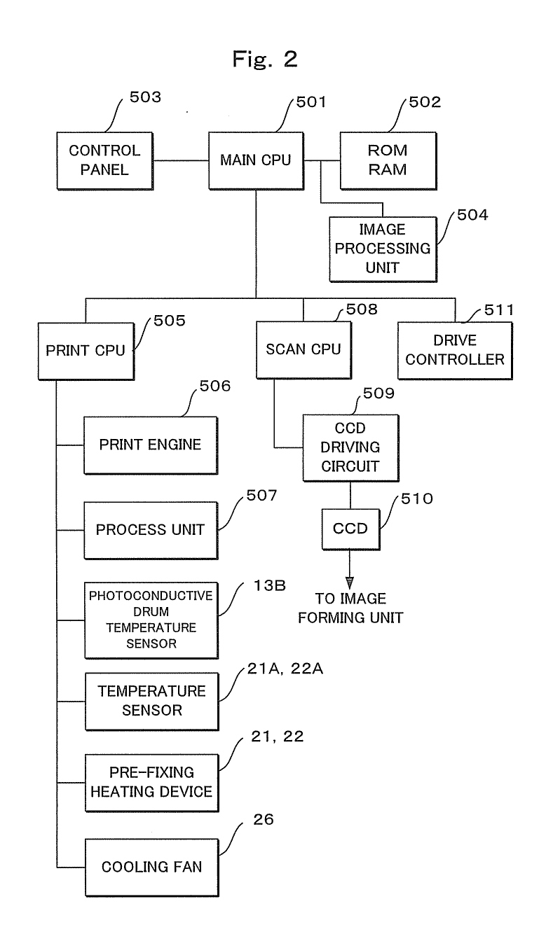

FIG. 2 is a block diagram showing the configuration of the image forming apparatus 1. As shown in FIG. 2, the image forming apparatus 1 has a main CPU 501 as a control unit, a control panel 503 as a display input device, a ROM and RAM 502 as a storage device, and an image processing unit 504 which carries out image processing.

The main CPU 501 connects to and controls a print CPU 505, a scan CPU 508 and a drive controller 511 provided in the image forming apparatus 1.

The print CPU 505 connects to and controls a print engine 506 which carries out image formation, a process unit 507 including the transfer device, the pre-fixing heating devices 21 and 22, and the cooling fan 26.

The print CPU 505 takes in outputs from the photoconductive drum temperature sensor 13B and the temperature sensors 21A and 22A.

The scan CPU 508 controls a CCD driving circuit 509 which drives a CCD 510. An output of the CCD 510 is outputted to the image forming unit.

The drive controller 511 controls the recording medium carrying mechanism 19.

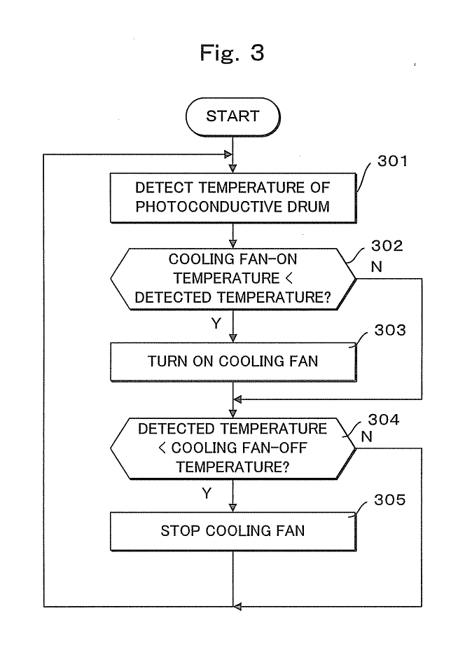

FIG. 3 is a flowchart showing operation of the image forming apparatus 1. As shown in FIG. 3, the image forming apparatus 1 carries out the following operation using the control unit. That is, in ACT 301, in the image forming apparatus 1 the photoconductive drum temperature sensor 13B detects the temperature of the photoconductive drum 13A.

In ACT 302, the image forming apparatus 1 determines whether the temperature detected by the photoconductive drum temperature sensor 13B is higher than the cooling fan-on temperature Ton. The image forming apparatus 1 proceeds to ACT 303 when the temperature detected by the photoconductive drum temperature sensor 13B is higher than the cooling fan-on temperature Ton, and proceeds to ACT 304 when the temperature is not higher than the cooling fan-on temperature Ton.

In ACT 303, the image forming apparatus 1 rotates the cooling fan 26.

In ACT 304, the image forming apparatus 1 determines whether the temperature detected by the photoconductive drum temperature sensor 13B is lower than the cooling fan-off temperature Toff. The image forming apparatus 1 proceeds to ACT 305 when the temperature detected by the photoconductive drum temperature sensor 13B is lower than the cooling fan-off temperature Toff, and returns to ACT 301 when the temperature is not lower than the cooling fan-off temperature Toff.

In ACT 305, the image forming apparatus 1 stops the cooling fan 26 and returns to ACT 301.

As described above, according to the embodiment, the image forming apparatus 1 has the pre-fixing heating device which is installed upstream from the fixing device 17 in the recording medium carrying direction and heats the image forming face of the recording medium, the temperature sensors 21A and 22A which detect the temperature of the pre-fixing heating device, the cooling device which cools the transfer belt 14B, the cooling fan 26 which cools the cooling device, the photoconductive drum temperature sensor 13B which is provided for each photoconductive drum 13A and detects the temperature of the photoconductive drum 13A, and the control unit which controls the heating temperature of the pre-fixing heating device to higher than the toner outer layer glass transition temperature Tg and lower than the toner melting point Tm and controls the temperature of the photoconductive drum 13A to lower than the threshold temperature.

Thus, there is an advantage that the temperature of the recoding medium prior to the fixing process can be maintained within a predetermined range and overheating of the transfer unit can be prevented.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. A pre-fixing heating device comprising:
a heating device which is installed upstream from a fixing device in a recording medium carrying direction and heats an image forming face of a recording medium;
an image carrier temperature sensor which detects temperature of an image carrier; and
a cooling device which cools a developer image carrier based on the detected temperature from the image carrier temperature sensor.

2. The device of claim 1, wherein the heating device is a pre-transfer heating device which is installed upstream from a transfer roller in the recording medium carrying direction and on a recording medium transfer face side of a recording medium carrying path.

3. The device of claim 2, wherein the pre-transfer heating device comprises:
a temperature sensor which detects a heating temperature; and
a control unit which controls the heating temperature to higher than a toner outer layer glass transition temperature and lower than a toner melting point.

4. The device of claim 1, wherein the heating device is a transfer unit heating device which heats a transfer unit.

5. The device of claim 4, wherein the transfer unit heating device comprises:
a temperature sensor which detects a heating temperature; and
a control unit which controls the heating temperature to higher than a toner outer layer glass transition temperature and lower than a toner melting point.

6. The device of claim 1, comprising a control unit which controls the temperature of the image carrier to lower than a threshold temperature, based on the detected temperature from the image carrier temperature sensor.

7. The device of claim 6, wherein the cooling device has a cooling fan, and
the control unit rotates the cooling fan when the temperature detected by the image carrier temperature sensor is determined as higher than the threshold temperature.

8. An image forming apparatus comprising:
an image carrier;
a developer image carrier which holds a developer image;
a fixing device which fixes the developer image transferred from the developer image carrier to a recording medium;
a heating device which is installed upstream from the fixing device in a recording medium carrying direction and heats an image forming face of the recording medium;
an image carrier temperature sensor which detects temperature of the image carrier; and
a cooling device which cools the developer image carrier based on the detected temperature from the image carrier temperature sensor.

9. The apparatus of claim 8, wherein the heating device is a pre-transfer heating device which is installed upstream from a transfer roller in the recording medium carrying direction and on a recording medium transfer face side of a recording medium carrying path.

10. The apparatus of claim 9, wherein the pre-transfer heating device comprises:
a temperature sensor which detects a heating temperature; and
a control unit which controls the heating temperature to higher than a toner outer layer glass transition temperature and lower than a toner melting point.

11. The apparatus of claim 8, wherein the heating device is a transfer unit heating device which heats a transfer unit.

12. The apparatus of claim 11, wherein the transfer unit heating device comprises:
a temperature sensor which detects a heating temperature; and
a control unit which controls the heating temperature to higher than a toner outer layer glass transition temperature and lower than a toner melting point.

13. The apparatus of claim 8, comprising a control unit which controls the temperature of the image carrier to lower than a threshold temperature, based on the detected temperature from the image carrier temperature sensor.

14. The apparatus of claim 13, wherein the cooling device has a cooling fan, and
the control unit rotates the cooling fan when the temperature detected by the image carrier temperature sensor is determined as higher than the threshold temperature.

15. An image forming method comprising:
heating an image forming face of a recording medium by a heating device which is installed upstream from a fixing device in a recording medium carrying direction;
transferring a developer image to the heated image forming face of the recoding medium;
fixing the developer image to the recording medium with the developer image transferred thereto;
detecting temperature of an image carrier by an image carrier temperature sensor; and
cooling a developer image carrier by a cooling device based on the detected temperature from the image carrier temperature sensor, and thus cooling the image carrier to a threshold temperature or lower.

16. The method of claim 15, wherein the heating device is a pre-transfer heating device which is installed upstream from a transfer roller in the recording medium carrying direction and on a recording medium transfer face side of a recording medium carrying path.

17. The method of claim 16, wherein the pre-transfer heating device comprises:
a temperature sensor which detects a heating temperature; and
a control unit which controls the heating temperature to higher than a toner outer layer glass transition temperature and lower than a toner melting point.

18. The method of claim 15, wherein the heating device is a transfer unit heating device which heats a transfer unit.

19. The method of claim 18, wherein the transfer unit heating device comprises a control unit which controls a heating temperature to higher than a toner outer layer glass transition temperature and lower than a toner melting point, based on the detected temperature from the image carrier temperature sensor.

20. The method of claim 15, comprising:
rotating a cooling fan when the temperature detected by the image carrier temperature sensor is determined as higher than the threshold temperature, and thus controlling the temperature of the image carrier to lower than the threshold temperature.
